(19) United States
(12) Patent Application Publication
(10) Pub. No.: US 2013/0008234 A1
(43) Pub. Date: Jan. 10, 2013

(54) PRE-INSTALLATION TURBOCHARGER BENCH TEST

(75) Inventor: Philip James Charles Vince, Columbia, SC (US)

(73) Assignee: International Engine Intellectual Property Company LLC, Lisle, IL (US)

(21) Appl. No.: 13/636,677

(22) PCT Filed: Mar. 10, 2011
(86) PCT No.: PCT/US11/27857

§ 371 Date: Sep. 22, 2012

Related U.S. Application Data
(60) Provisional application No. 61/316,692, filed on Mar. 23, 2010.

(51) Int. Cl. G01M 15/02

(52) U.S. Cl. 73/49.7

(57) ABSTRACT

Test apparatus (30) and method (70) for testing a turbocharger (20) having a turbine (20T) that operates a compressor (20C). A compressed air source (32) operates the turbine; and a device (42) creates back-pressure at an outlet (20CO) of the compressor.

### TECHNICAL FIELD

This disclosure relates to internal combustion engine turbochargers, and in particular to pre-installation testing of such turbochargers.

### BACKGROUND

An internal combustion engine turbocharger comprises a turbine that is operated by engine exhaust to drive a compressor that creates superatmospheric pressure, i.e. boost, in an engine intake manifold through which charge air enters engine cylinders to support combustion of fuel. A variable geometry turbocharger and a wastegate turbocharger are two types.

A turbocharged internal combustion engine that propels a motor vehicle such as a commercial truck can provide improved fuel economy and performance.

### SUMMARY OF THE DISCLOSURE

This disclosure relates to an apparatus and a method for testing newly manufactured turbochargers before they are installed on internal combustion engines.

In this way, a turbocharger that is found non-compliant during testing will not be installed on an engine. This can yield significant savings in time, cost, and inconvenience that would be associated with having to remove a non-compliant turbocharger after its installation on an engine.

Compressed air is used, instead of hot exhaust gas, to operate the turbine. Pressures in the range of 0.5-5.0 bar simulate typical operating pressures in a turbocharger that is installed on an internal combustion engine. Pressure and massflow rate are varied to simulate different turbine operating conditions that would occur in such an engine. Atmospheric air is drawn into the compressor through an air filter. Back-pressure at the compressor outlet is created by a back-pressure control valve that is controlled to restrict compressor flow in varying degrees thereby simulating various engine conditions. The wastegate of a wastegate type turbocharger is operated in varying degrees. Massflow rates from the compressor outlet are measured for different operating conditions and evaluated against specified values indicative of a compliant turbocharger. The evaluation determines if a turbocharger is or is not compliant.

One general aspect of the disclosure relates to test apparatus for testing a turbocharger having a turbine that operates a compressor. The apparatus comprises a compressed air source for operating the turbine; and a device for creating back-pressure at an outlet of the compressor.

A more specific aspect relates to a supply pressure control loop for setting air pressure at an inlet of the turbine to which the compressed air source supplies air. The supply pressure control loop comprises a pressure transducer for measuring air pressure at the inlet of the turbine, a supply pressure control valve for controlling air pressure at the inlet of the turbine, and a supply pressure control valve controller for controlling the supply pressure control valve to cause air pressure measured by the pressure transducer to correspond to a specified air pressure.

Another more specific aspect relates to a supply flow control loop for setting massflow rate of air entering the inlet of the turbine. The supply flow control loop comprises a massflow meter for measuring massflow rate of air entering the inlet of the turbine, a supply flow control valve for controlling massflow rate of air entering the inlet of the turbine, and a supply flow control valve controller for controlling the supply flow control valve to cause massflow rate of air measured by the massflow meter to correspond to a specified massflow rate.

Another more specific aspect relates to a compressor outlet back-pressure control loop comprising a compressor outlet pressure transducer for measuring pressure at the outlet of the compressor and a compressor back-pressure control valve controller for controlling a compressor back-pressure control valve to cause air pressure measured by the compressor outlet pressure transducer to correspond to a specified back-pressure. A compressor outlet massflow meter measures massflow rate of air leaving the compressor outlet. A compressor supply pressure transducer measures pressure at an inlet of the compressor.

Another general aspect of the disclosure relates to a method for testing a turbocharger having a turbine that operates a compressor. The method comprises using a compressed air source to operate the turbine; and with the turbine operating the compressor, creating back-pressure at an outlet of the compressor by using a device connected to the compressor outlet to restrict flow coming from the compressor outlet.

A more specific aspect relates to using a supply pressure control loop to set air pressure at an inlet of the turbine to which the compressed air source supplies air, using a pressure transducer to measure air pressure at the inlet of the turbine, and controlling a supply pressure control valve to cause air pressure measured by the pressure transducer to correspond to a specified air pressure.

Another more specific aspect relates to using a supply flow control loop to set massflow rate of air entering the inlet of the turbine, using a massflow meter to measure massflow rate of air entering the inlet of the turbine, and controlling a supply flow control valve through which air enters the turbine inlet to cause massflow rate of air measured by the massflow meter to correspond to a specified massflow rate.

Another more specific aspect relates to using a compressor back-pressure control valve through which air leaving the outlet of the compressor passes to create back-pressure at the outlet of the compressor, using a compressor outlet pressure transducer to measure pressure at the outlet of the compressor, and controlling the compressor back-pressure control valve to cause air pressure measured by the compressor outlet pressure transducer to correspond to a specified back-pressure. A compressor outlet massflow meter is used for measuring massflow rate of air leaving the compressor outlet, and a compressor supply pressure transducer is used for measuring pressure at an inlet of the compressor.

The foregoing summary is accompanied by further detail of the disclosure presented in the Detailed Description below with reference to the following drawings that are part of the disclosure.

### BRIEF DESCRIPTION OF THE DRAWINGS

FIG. 1 is a general schematic diagram of a waste-gate type turbocharger installed on a diesel engine.

FIG. 2 is schematic diagram of apparatus for testing the turbocharger prior to its installation on the engine.

FIG. 3 is schematic diagram of a test method performed by the apparatus of FIG. 2.

### DETAILED DESCRIPTION

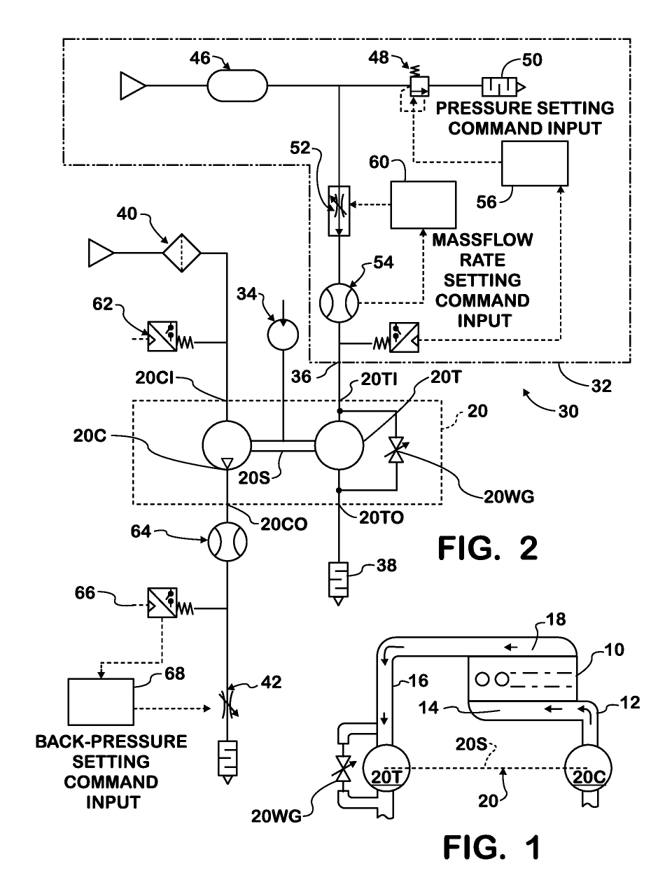

FIG. 1 shows a multi-cylinder engine 10 having structural components assembled together to form engine cylinders within which combustion of fuel occurs to operate a kinematic mechanism comprising pistons, connecting rods, and a crankshaft. Fresh air for supporting combustion of fuel is delivered to cylinders of engine 10 through an intake system 12 that comprises an intake manifold 14 serving the engine cylinders.

Engine 10 further comprises an exhaust system 16 that comprises an exhaust manifold 18 at which combustion-created exhaust from the engine cylinders enters the exhaust system for conveyance to a tailpipe through which the exhaust passes into the surrounding atmosphere.

A turbocharger 20 comprises a turbine 20T in exhaust system 16 and a compressor 20C in intake system 12. Engine exhaust leaving exhaust manifold 18 passes through turbine 20T before continuing through the remainder of exhaust system 16 to the tailpipe. The exhaust that passes through turbine 20T operates turbocharger 20.

Turbine 20T is coupled to compressor 20C by a shaft 20S to cause compressor 20C to compress air passing through intake system 12, thereby developing boost for engine 10. Turbocharger 20 is a wastegate type that comprises a wastegate 20WG. The extent to which wastegate 20WG opens determines the quantity of air that is shunted away from the turbine wheel which is the rotating part of turbine 20T that rotates the compressor wheel of compressor 20C that draws intake air through the compressor.

FIG. 2 shows apparatus 30 for testing turbocharger 20 prior to its installation on the engine. Apparatus 30 comprises a compressed air source 32 for operating turbine 20T and an oil source 34 for lubricating shaft 20S.

Turbocharger 20 is placed in association with apparatus 30 by connecting an inlet 20TI of turbine 20T inlet to an outlet 36 of compressed air source 32, by connecting an outlet 20TO of turbine 20T to an inlet of an air exhaust muffler 38 whose outlet is open to atmosphere, by communicating an inlet 20CI of compressor 20C through a fresh air filter 40 to atmosphere, and by connecting an outlet 20CO of compressor 20C to an inlet of a back-pressure control valve 42 whose outlet is communicated through an air exhaust muffler 44 to atmosphere. When compressed air source 32 is operating turbine 20T during a test, the pressure at turbine inlet 20TI and the massflow rate through turbine 20T are controlled in accordance with a test sequence of different combinations of pressure and massflow rate.

Compressed air source 32 comprises a tank 46 into which air is compressed by an air compressor (not shown) and a supply pressure control valve 48 which can vent some air coming from tank 46 through an air exhaust muffler 50 to atmosphere in order to set a selected magnitude for pressure of air being supplied through a supply flow control valve 52 and a massflow meter 54 to turbine inlet 20TI. A supply pressure control loop 56 includes an electronic controller to which a turbine supply pressure transducer 58 provides a measure of pressure at turbine inlet 20TI. Supply pressure control loop 56 adjusts supply pressure control valve 48 to set pressure at turbine inlet 20TI to a pressure setting command input to the loop. Supply pressure control loop 56 provides feedback control that assures correspondence of actual pressure with the pressure setting command input.

Massflow meter 54 provides a measurement of massflow rate of air passing through turbine 20T to a supply massflow rate control loop 60 which includes an electronic controller for adjusting supply flow control valve 52 to assure a massflow rate of air passing through turbine 20T that corresponds to a massflow rate setting command input to the loop. Collectively, the two control loops 56, 60 set the power input to the turbine wheel of turbine 20T.

A compressor supply pressure transducer 62 measures air pressure at compressor inlet 20CI. A compressor outlet massflow meter 64 measures massflow rate of air leaving compressor outlet 20CO. Back-pressure at compressor outlet 20CO is measured by a compressor outlet pressure transducer 66. That measurement is used by a compressor back-pressure control loop 68 to adjust back-pressure control valve 42 in order to set back-pressure at compressor outlet 20CO during testing of turbocharger 20 to a compressor back-pressure setting command input to the loop. In this way, compressor back-pressure control loop 68 provides feedback control that assures correspondence of actual back-pressure with the back-pressure setting command input.

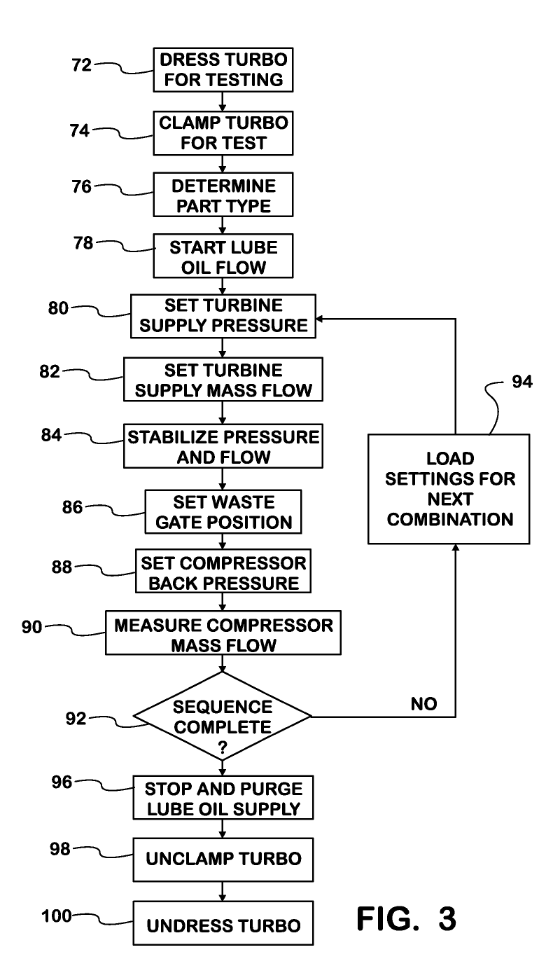

FIG. 3 shows steps of a method 70 for testing turbocharger 20. A first step 72 comprises dressing turbocharger 20 in preparation for its installation in apparatus 30 by a subsequent clamping step 74. The particular type (or model) of turbocharger (step 76) determines specific combinations of command input settings that are to be applied to the turbocharger during its testing.

With the turbocharger installed in apparatus 30, lubricating oil is pumped from oil source 34 to lubricate shaft 20S (step 78). Turbine 20T is then operated with turbine supply pressure by supply pressure control loop 56 being set to a specified pressure setting command (step 80) and turbine supply massflow rate being set by supply massflow rate control loop 60 to a specified massflow rate setting command (step 82). Both supply pressure and supply massflow rate are allowed to stabilize (step 84).

Waste gate 20WG is set to a specified position (step 86). Compressor back-pressure is set by compressor back-pressure control loop 68 to a specified test pressure (step 88), and the massflow rate from compressor 20C is measured (step 90).

The sequence of steps 80 through 90 is then repeated (steps 92, 94) for various combinations of pressure setting command inputs to control loop 56, massflow rate command inputs to loop 60, positions of waste gate positions 20WG, and compressor back-pressure setting command inputs to control loop 68. For each combination, compressor massflow rate is measured.

The various measurements of compressor massflow rate taken for different operational conditions of turbocharger 20 are evaluated against specified values that define a compliant turbocharger. If the measurements are within allowed tolerances, the turbocharger is deemed compliant and suitable for installation on an engine. If the measurements are not within allowed tolerances, the turbocharger is deemed non-compliant, allowing it to be repaired or rebuilt for compliance, before installation on an engine.

Once the test sequence has been completed (as determined by step 92), pumping of oil to shaft 20S is stopped and the oil lines are purged (step 96). The turbocharger can then be removed from apparatus 30 (step 98) and undressed (step 100).

What is claimed is:

1. Test apparatus for testing a turbocharger having a turbine that operates a compressor, the apparatus comprising:
a compressed air source for operating the turbine;
and a device for creating back-pressure at an outlet of the compressor.

2. Test apparatus as set forth in claim 1 further comprising a supply pressure control loop for setting air pressure at an inlet of the turbine to which the compressed air source supplies air.

3. Test apparatus as set forth in claim 2 in which the supply pressure control loop comprises a pressure transducer for measuring air pressure at the inlet of the turbine, a supply pressure control valve for controlling air pressure at the inlet of the turbine, and a supply pressure control valve controller for controlling the supply pressure control valve to cause air pressure measured by the pressure transducer to correspond to a specified air pressure.

4. Test apparatus as set forth in claim 1 further comprising a supply flow control loop for setting massflow rate of air entering the inlet of the turbine.

5. Test apparatus as set forth in claim 4 in which the supply flow control loop comprises a massflow meter for measuring massflow rate of air entering the inlet of the turbine, a supply flow control valve for controlling massflow rate of air entering the inlet of the turbine, and a supply flow control valve controller for controlling the supply flow control valve to cause massflow rate of air measured by the massflow meter to correspond to a specified massflow rate.

6. Test apparatus as set forth in claim 1 further comprising a supply pressure control loop for setting air pressure at an inlet of the turbine to which the compressed air source supplies air and a supply flow control loop for setting massflow rate of air entering the inlet of the turbine.

7. Test apparatus as set forth in claim 1 in which the device for creating back-pressure at an outlet of the compressor comprises a compressor back-pressure control valve.

8. Test apparatus as set forth in claim 7 further comprising a compressor back-pressure control loop comprising a compressor outlet pressure transducer for measuring pressure at the outlet of the compressor and a compressor back-pressure control valve controller for controlling the compressor back-pressure control valve to cause air pressure measured by the compressor outlet pressure transducer to correspond to a specified back-pressure.

9. Test apparatus as set forth in claim 8 further comprising a compressor outlet massflow meter for measuring massflow rate of air leaving the compressor outlet.

10. Test apparatus as set forth in claim 9 further comprising a compressor supply pressure transducer for measuring pressure at an inlet of the compressor.

11. Test apparatus as set forth in claim 9 further comprising an air exhaust muffler through which that has passed through the compressor and the compressor outlet back-pressure control valve passes to atmosphere.

12. Test apparatus as set forth in claim 1 further comprising an air exhaust muffler through which air that has passed through the turbine passes to atmosphere.

13. A method for testing a turbocharger having a turbine that operates a compressor, the method comprising:
using a compressed air source to operate the turbine;
and with the turbine operating the compressor, creating back-pressure at an outlet of the compressor by using a device connected to the compressor outlet to restrict flow coming from the compressor outlet.

14. A method as set forth in claim 13 further comprising using a supply pressure control loop to set air pressure at an inlet of the turbine to which the compressed air source supplies air.

15. A method as set forth in claim 14 further comprising using a pressure transducer to measure air pressure at the inlet of the turbine, and controlling a supply pressure control valve to cause air pressure measured by the pressure transducer to correspond to a specified air pressure.

16. A method as set forth in claim 13 further comprising using a supply flow control loop to set massflow rate of air entering the inlet of the turbine.

17. A method as set forth in claim 16 further comprising using a massflow meter to measure massflow rate of air entering the inlet of the turbine, controlling a supply flow control valve through which air enters the turbine inlet to cause massflow rate of air measured by the massflow meter to correspond to a specified massflow rate.

18. A method as set forth in claim 13 further comprising using a supply pressure control loop to set air pressure at an inlet of the turbine to which the compressed air source supplies air and using a supply flow control loop to set massflow rate of air entering the inlet of the turbine.

19. A method as set forth in claim 13 further comprising using a compressor back-pressure control valve through which air leaving the outlet of the compressor passes to create back-pressure at the outlet of the compressor.

20. A method as set forth in claim 19 further comprising using a compressor outlet pressure transducer to measure pressure at the outlet of the compressor and using a compressor back-pressure control valve controller to cause air pressure measured by the compressor outlet pressure transducer to correspond to a specified back-pressure.

21. A method as set forth in claim 20 further comprising using a compressor outlet massflow meter to measure massflow rate of air leaving the compressor outlet.

22. A method as set forth in claim 21 further comprising a compressor supply pressure transducer for measuring pressure at an inlet of the compressor.

23. A method as set forth in claim 21 further comprising passing air that has passed through the compressor through an air exhaust muffler.

24. A method as set forth in claim 13 further comprising passing air that has passed through the turbine through an air exhaust muffler.
